(19) United States
(12) Patent Application Publication
(10) Pub. No.: US 2026/0154390 A1
(43) Pub. Date: Jun. 4, 2026

(54) METHOD AND SYSTEM FOR CONTINUOUS AUTHENTICATION OF PARTICIPANTS IN COMMUNICATION SESSIONS

(71) Applicant: TURANT INC., Saratoga, CA (US)

(72) Inventors: Anurag Goel, Saratoga, CA (US); Sairam Sankaranarayanan, San Ramon, CA (US)

(21) Appl. No.: 19/405,296

(22) Filed: Dec. 1, 2025

Related U.S. Application Data
(60) Provisional application No. 63/727,188, filed on Dec. 2, 2024.

(51) Int. Cl. G06F 21/32; G10L 17/18; G10L 17/22; G10L 21/0308

(52) U.S. Cl. CPC G06F 21/32; G10L 17/18; G10L 17/22; G10L 21/0308; G06F 2221/2103

(57) ABSTRACT

A computer-implemented method provides continuous authentication for a participant in a communication session. The method involves accessing a reference biometric record comprising original voice recordings of the participant and capturing a live voice sample from the participant during the session. The live voice sample is subjected to a parallel analysis, which includes a biometric comparison process to generate an authentication score and a voice liveness detection process. A potential unauthorized access event is determined based on the authentication score in comparison to an authentication threshold and a result of the voice liveness detection. Responsive to determining the potential unauthorized access event, a challenge verification procedure is automatically executed. This procedure includes transmitting a prompt for a challenge-response task, receiving a challenge voice sample, and authenticating the challenge voice sample to generate a challenge result. An authentication status of the participant is then modified based on the challenge result.

### CROSS-REFERENCE TO RELATED APPLICATION

This application claims the benefit of priority under 35 U.S.C. § 119(e) based on U.S. Provisional Patent Application having Application No. 63/727,188 filed on Dec. 2, 2024, and entitled “System and Method for Continuous Biometric Authentication in Communication Sessions”, which is hereby incorporated herein by reference in its entirety.

### FIELD OF THE INVENTION

The present disclosure relates generally to the field of biometric authentication and security systems. More specifically, the present disclosure pertains to systems and methods for continuous and real-time authentication of multiple participants during ongoing communication sessions using voice biometrics and artificial intelligence technologies.

### BACKGROUND

In modern digital communications, secure authentication of participants has become a fundamental requirement across various domains including business meetings, financial transactions, and sensitive governmental communications. Communication sessions, whether conducted through audio conferences, video meetings, or telephonic conversations, rely on verification mechanisms to ensure the identity of participants. These mechanisms are intended to prevent unauthorized access and maintain the integrity and confidentiality of the information being exchanged, which is often sensitive in a corporate, financial, or governmental context.

Several challenges have emerged in maintaining security of communication sessions, particularly with advancement of artificial intelligence technologies. A significant concern involves potential unauthorized access during ongoing sessions, which could enable various security breaches. For example, an authorized participant may be willingly substituted, such as during a remote job interview where an applicant switches with another person for technical questions. An unwilling substitution may also occur, where a person on an impacted computer in a live video communication is switched with a video stream of an impersonator. Additionally, the rise of deepfake technologies and generative artificial intelligence has created new mediums for advanced attacks through artificial replication of biometric characteristics, such as a voice, making an impersonator sound identical to an authorized participant.

Traditionally communication platforms implement authentication methods including passwords, biometric verification, and multi-factor authentication systems to validate participant identities before granting access to secure sessions. These authentication methods typically focus on verifying a participant's identity at the beginning of a communication session through various means such as passwords, PINs, or initial biometric checks. Some systems may employ an initial voice biometric check, such as text-dependent speaker verification requiring a predefined phrase, to authenticate a user at the start of a session. This initial authentication approach has been widely adopted across different platforms and applications, from video conferencing systems to telephonic communications.

However, this initial, one-time authentication approach has a significant vulnerability: the potential for unauthorized access or identity substitution during an ongoing communication session, even after initial authentication has been successfully completed. This vulnerability creates opportunities for malicious actors to compromise sensitive communications, either through the willing substitution of participants or through sophisticated deepfake audio and video implementations.

Some solutions have been proposed and implemented to address authentication concerns in communication sessions. These include the use of periodic password re-entry, continuous video monitoring, and basic voice recognition systems. Some platforms have implemented additional security layers such as watermarking and encryption to protect against unauthorized access and maintain session integrity.

While these conventional solutions offer some improvement in security, they have significant limitations. Periodic password re-entry can be easily overcome by known automating solutions. Video monitoring alone cannot detect sophisticated deepfake implementations. Basic voice recognition systems may be susceptible to recorded voice attacks or synthetic voice generation. Moreover, these solutions typically operate in isolation, lacking the comprehensive and continuous verification necessary for maintaining session security throughout its duration.

In light of these challenges, there exists a need for an advanced system and method capable of providing continuous, real-time authentication of participants throughout the entire duration of a communication session. Such a system should be able to detect and respond to unauthorized access attempts, including those using advanced deepfake or replay attack vectors, while maintaining a seamless and non-intrusive user experience. Furthermore, such a system should be able to adapt to varying environmental conditions, such as high ambient noise, while maintaining consistent authentication accuracy.

### SUMMARY

The present disclosure addresses the aforementioned needs by providing methods and systems for continuous authentication in communication sessions using advanced biometric analysis and artificial intelligence technologies. The present disclosure offers a comprehensive solution for maintaining session security through ongoing participant verification, combining multiple authentication algorithms with sophisticated deepfake detection and challenge verification procedures.

In an aspect, a computer-implemented method for continuous authentication of a participant in a communication session is provided. The method comprises: accessing, by one or more processors, a reference biometric record associated with the participant, wherein the reference biometric record comprises one or more original voice recordings of the authorized participant; capturing, by one or more processors, a live voice sample from the participant during the communication session; subjecting, by one or more processors, the live voice sample to a parallel analysis, the parallel analysis comprising: a biometric comparison process, wherein the live voice sample is compared against the reference biometric record to generate an authentication score; and a voice liveness detection process, wherein a voice liveness verification test is performed on the live voice sample; determining, by one or more processors, that a potential unauthorized access event has occurred based on the authentication score in comparison to an authentication threshold and a result of the voice liveness detection process; responsive to determining the potential unauthorized access event, automatically executing a challenge verification procedure, the challenge verification procedure comprising: transmitting, by one or more processors, a prompt for a challenge-response task to the participant; receiving, by one or more processors, a challenge voice sample from the participant in response to the prompt; and performing, by one or more processors, an authentication of the challenge voice sample to generate a challenge result; and modifying, by one or more processors, an authentication status of the participant based on the challenge result.

In some embodiments, the communication session comprises a plurality of participants, and the method further comprises prior to subjecting the live voice sample to the parallel analysis, performing speaker identification on the live voice sample to separate the live voice sample into one or more individual participant voice samples, wherein the live voice sample comprises a multi-speaker audio stream.

In some embodiments, performing speaker identification comprises: generating speaker embeddings for segments of the multi-speaker audio stream using a deep neural network model; and performing clustering of the generated speaker embeddings to identify distinct speakers corresponding to the plurality of participants.

In some embodiments, transmitting the prompt for the challenge-response task comprises transmitting a separate authentication request to a registered device associated with the participant via a secure out-of-band channel.

In some embodiments, the challenge-response task comprises prompting the participant to speak a generated random sequence of digits.

In some embodiments, the biometric comparison process is performed by one or more parallel authentication algorithms selected from the group consisting of: i-vector based authentication, d-vector based authentication, x-vector based authentication, and neural network based authentication.

In some embodiments, the biometric comparison process further comprises: calculating a similarity value between the live voice sample and the reference biometric record; comparing the similarity value to a predefined anti-replay threshold; and responsive to determining the similarity value exceeds the anti-replay threshold, determining the potential unauthorized access event has occurred.

In some embodiments, the method further comprises: determining ambient noise conditions in the communication session by analyzing the live voice sample; and dynamically adjusting the authentication threshold based on the determined ambient noise conditions.

In some embodiments, the reference biometric record comprises a first component including text-dependent voice samples of the participant and a second component including a text-independent free speech audio sample.

In some embodiments, the method further comprises prompting the participant to perform periodic updates of the reference biometric record at predetermined intervals to account for natural changes in biometric characteristics.

In some embodiments, the reference biometric record is stored as a non-fungible token in a blockchain network.

In some embodiments, subjecting the live voice sample to the parallel analysis is performed on a user device associated with the participant; and responsive to determining the potential unauthorized access event, the challenge verification procedure is executed on a remote server.

In some embodiments, the method further comprises: determining a network bandwidth quality for the communication session; and dynamically adjusting a complexity of feature vectors extracted during the biometric comparison process based on the determined network bandwidth quality.

In some embodiments, the method further comprises: analyzing a context of the communication session; and dynamically adjusting a periodic interval for capturing the live voice sample based on the context, wherein the context comprises a new participant joining the communication session or a change in conversation topic.

In some embodiments, the reference biometric record is part of a global authentication model, and further comprising: updating a local model on a user device using the live voice sample; and aggregating updates from the local model into the global authentication model without transmitting the live voice sample from the user device.

In another aspect, a system for continuous authentication of a participant in a communication session is provided. The system comprises: one or more processors; and a memory communicatively coupled to the one or more processors, the memory storing program instructions which, when executed by the one or more processors, cause the one or more processors to: access a reference biometric record associated with the participant, wherein the reference biometric record comprises one or more original voice recordings of the authorized participant; receive a live voice sample from the participant captured during the communication session; subject the live voice sample to a parallel analysis, the parallel analysis comprising: a biometric comparison process, wherein the live voice sample is compared against the reference biometric record to generate an authentication score; and a voice liveness detection process, wherein a voice liveness verification test is performed on the live voice sample; determine that a potential unauthorized access event has occurred based on the authentication score in comparison to an authentication threshold and a result of the voice liveness detection process; responsive to determining the potential unauthorized access event, automatically execute a challenge verification procedure, the challenge verification procedure comprising: transmitting a prompt for a challenge-response task to the participant; receiving a challenge voice sample from the participant in response to the prompt; and performing an authentication of the challenge voice sample to generate a challenge result; and modify an authentication status of the participant based on the challenge result.

In some embodiments, the communication session comprises a plurality of participants, and wherein the instructions, when executed by the one or more processors, further cause the one or more processors to prior to subjecting the live voice sample to the parallel analysis, perform speaker identification on the live voice sample to separate the live voice sample into one or more individual participant voice samples, wherein the live voice sample comprises a multi-speaker audio stream.

In some embodiments, the system further comprises: a user device associated with the participant; and a remote server communicatively coupled to the user device, wherein the one or more processors comprise a first processor of the user device and a second processor of the remote server, wherein the instructions that cause the one or more processors to subject the live voice sample to the parallel analysis are executed by the first processor, and wherein the instructions that cause the one or more processors to execute the challenge verification procedure are executed by the second processor.

In some embodiments, the system further comprises: a microphone configured to capture the live voice sample; and a registered device associated with the participant, wherein the registered device is separate from a device utilized for the communication session, wherein the instructions that cause the one or more processors to transmit the prompt for the challenge-response task comprise instructions to transmit the prompt to the registered device via a secure out-of-band channel.

In yet another aspect, a non-transitory computer-readable storage medium storing program instructions is provided which, when executed by one or more processors, cause the one or more processors to perform the method as described above.

Still, other aspects, features, and advantages of the invention are readily apparent from the following detailed description, simply by illustrating a number of particular embodiments and implementations, including the best mode contemplated for carrying out the invention. The invention is also capable of other and different embodiments, and its several details may be modified in various obvious respects, all without departing from the scope of the invention. Accordingly, the drawings and description are to be regarded as illustrative in nature, and not as restrictive.

### BRIEF DESCRIPTION OF THE FIGURES

For a more complete understanding of example embodiments of the present disclosure, reference is now made to the following descriptions taken in connection with the accompanying drawings in which:

FIG. 1 illustrates a system that may reside on and may be executed by a computer, which may be connected to a network, in accordance with one or more exemplary embodiments of the present disclosure.

FIG. 2 illustrates a diagrammatic view of a server, in accordance with one or more exemplary embodiments of the present disclosure.

FIG. 3 illustrates a diagrammatic view of a user device, in accordance with one or more exemplary embodiments of the present disclosure.

FIG. 4 illustrates a flowchart of a method for continuous authentication of participant(s) in a communication session, in accordance with one or more exemplary embodiments of the present disclosure.

FIG. 5 illustrates a detailed flowchart of a speaker identification process involved in the present method for continuous authentication, in accordance with one or more exemplary embodiments of the present disclosure.

FIG. 6 illustrates a detailed flowchart of a parallel analysis and anomaly detection process involved in the present method for continuous authentication, in accordance with one or more exemplary embodiments of the present disclosure.

FIG. 7 illustrates a detailed flowchart of a challenge verification procedure involved in the present method for continuous authentication, in accordance with one or more exemplary embodiments of the present disclosure.

FIG. 8 illustrates a schematic of a dynamic threshold adjustment mechanism for implementing the present method for continuous authentication, in accordance with one or more exemplary embodiments of the present disclosure.

FIG. 9 illustrates a schematic of a hybrid on-device/cloud architecture for implementing the present method for continuous authentication, in accordance with one or more exemplary embodiments of the present disclosure.

FIG. 10 illustrates a schematic of a system for continuous authentication of participant(s) in a communication session, in accordance with one or more exemplary embodiments of the present disclosure.

FIG. 11 illustrates a distributed system architecture for hybrid and out-of-band operations of the present system for continuous authentication, in accordance with one or more exemplary embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to these specific details.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. In present implementations, the used language for training may be one of Python, Tensorflow, Bazel, C, C++. Further, decoder in user device (as will be discussed) may use C, C++ or any processor specific ISA. Furthermore, assembly code inside C/C++ may be utilized for specific operation. Also, ASR (automatic speech recognition) and G2P decoder along with entire user system can be run in embedded Linux (any distribution), Android, iOS, Windows, or the like, without any limitations. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

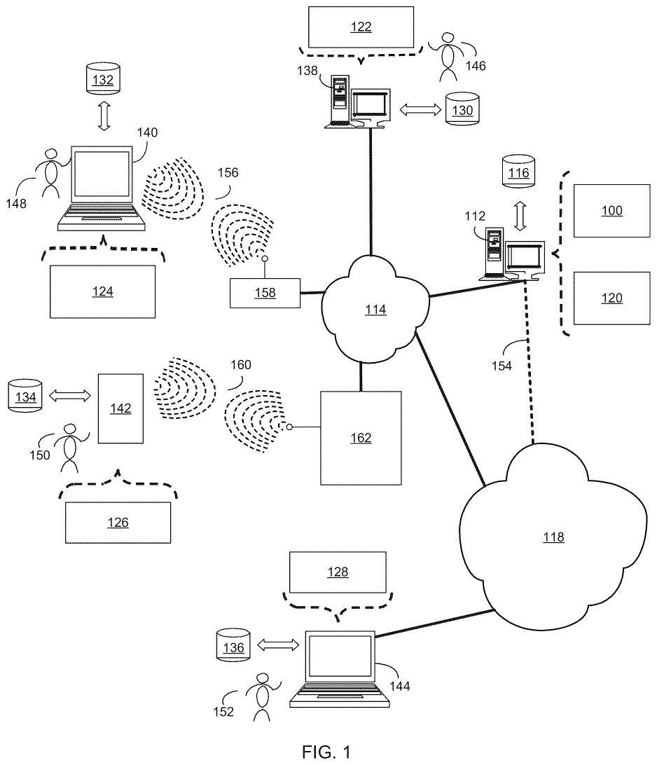

Referring to example implementation of FIG. 1, there is shown a computing system 100 that may reside on and may be executed by a computer (e.g., computer 112), which may be connected to a network (e.g., network 114) (e.g., the internet or a local area network). Examples of computer 112 may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, a portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft Windows®; Mac OS X®; Red Hat Linux®, or a custom operating system.

In some implementations, the instruction sets and subroutines of computing system 100, which may be stored on storage device, such as storage device 116, coupled to computer 112, may be executed by one or more processors (not shown) and one or more memory architectures included within computer 112. In some implementations, storage device 116 may include but is not limited to: a hard disk drive; a flash drive, a tape drive; an optical drive; a RAID array (or other array); a random-access memory (RAM); and a read-only memory (ROM).

In some implementations, network 114 may be connected to one or more secondary networks (e.g., network 118), examples of which may include but are not limited to: a local area network; a wide area network; or an intranet, for example.

In some implementations, computer 112 may include a data store, such as a database (e.g., relational database, object-oriented database, triplestore database, etc.) and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, computing system 100 may be a component of the data store, a standalone application that interfaces with the above noted data store and/or an applet / application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute application 120 for continuous authentication in a communication session. In some implementations, computing system 100 and/or application 120 may be accessed via one or more of client applications 122, 124, 126, 128. In some implementations, computing system 100 may be a standalone application, or may be an applet/application/script/extension that may interact with and/or be executed within application 120, a component of application 120, and/or one or more of client applications 122, 124, 126, 128. In some implementations, application 120 may be a standalone application, or may be an applet/application/script/extension that may interact with and/or be executed within computing system 100, a component of computing system 100, and/or one or more of client applications 122, 124, 126, 128. In some implementations, one or more of client applications 122, 124, 126, 128 may be a standalone application, or may be an applet/application/script/extension that may interact with and/or be executed within and/or be a component of computing system 100 and/or application 120. Examples of client applications 122, 124, 126, 128 may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to user devices 138, 140, 142, 144, may be executed by one or more processors and one or more memory architectures incorporated into user devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of user devices 138, 140, 142, 144 (and/or computer 112) may include, but are not limited to, a personal computer (e.g., user device 138), a laptop computer (e.g., user device 140), a smart/data-enabled, cellular phone (e.g., user device 142), a notebook computer (e.g., user device 144), a tablet (not shown), a server (not shown), a television (not shown), a smart television (not shown), a media (e.g., video, photo, etc.) capturing device (not shown), and a dedicated network device (not shown). User devices 138, 140, 142, 144 may each execute an operating system, examples of which may include but are not limited to, Android, Apple iOS, Mac OS X; Red Hat Linux, or a custom operating system.

In some implementations, one or more of client applications 122, 124, 126, 128 may be configured to effectuate some or all of the functionality of computing system 100 (and vice versa). Accordingly, in some implementations, computing system 100 may be a purely server-side application, a purely client-side application, or a hybrid server-side/client-side application that is cooperatively executed by one or more of client applications 122, 124, 126, 128 and/or computing system 100.

In some implementations, one or more of client applications 122, 124, 126, 128 may be configured to effectuate some or all of the functionality of application 120 (and vice versa). Accordingly, in some implementations, application 120 may be a purely server-side application, a purely client-side application, or a hybrid server-side/client-side application that is cooperatively executed by one or more of client applications 122, 124, 126, 128 and/or application 120. As one or more of client applications 122, 124, 126, 128, computing system 100, and application 120, taken singly or in any combination, may effectuate some or all of the same functionality, any description of effectuating such functionality via one or more of client applications 122, 124, 126, 128, computing system 100, application 120, or combination thereof, and any described interaction(s) between one or more of client applications 122, 124, 126, 128, computing system 100, application 120, or combination thereof to effectuate such functionality, should be taken as an example only and not to limit the scope of the disclosure.

In some implementations, one or more of users 146, 148, 150, 152 may access computer 112 and computing system 100 (e.g., using one or more of user devices 138, 140, 142, 144) directly through network 114 or through secondary network 118. Further, computer 112 may be connected to network 114 through secondary network 118, as illustrated with phantom link line 154. Computing system 100 may include one or more user interfaces, such as browsers and textual or graphical user interfaces, through which users 146, 148, 150, 152 may access computing system 100.

In some implementations, the various user devices may be directly or indirectly coupled to communication network, such as communication network 114 and communication network 118, hereinafter simply referred to as network 114 and network 118, respectively. For example, user device 138 is shown directly coupled to network 114 via a hardwired network connection. Further, user device 144 is shown directly coupled to network 118 via a hardwired network connection. User device 140 is shown wirelessly coupled to network 114 via wireless communication channel 156 established between user device 140 and wireless access point (i.e., WAP) 158, which is shown directly coupled to network 114. WAP 158 may be, for example, an IEEE 802.11a, 802.11b, 802.11g, Wi-Fi, RFID, and/or Bluetooth (including Bluetooth Low Energy) device that is capable of establishing wireless communication channel 156 between user device 140 and WAP 158. User device 142 is shown wirelessly coupled to network 114 via wireless communication channel 160 established between user device 142 and cellular network/ bridge 162, which is shown directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example, Bluetooth (including Bluetooth Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

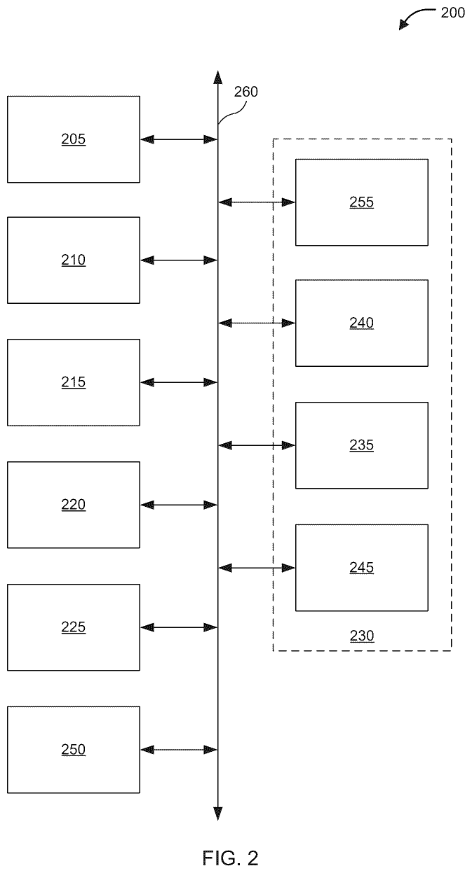

The computing system 100 may include a server (such as server 200, as shown in FIG. 2) for continuous authentication in a communication session. In the present implementations, the computing system 100 itself may be embodied as the server 200. Herein, FIG. 2 is a block diagram of an example of the server 200 capable of implementing embodiments according to the present disclosure. In the example of FIG. 2, the server 200 may include a processing unit 205 for running software applications (such as, the application 120 of FIG. 1) and optionally an operating system. As illustrated, the server 200 may further include a database 210 which stores applications and data for use by the processing unit 205. Storage 215 provides non-volatile storage for applications and data and may include fixed disk drives, removable disk drives, flash memory devices, and CD-ROM, DVD-ROM or other optical storage devices. An optional user input device 220 may include devices that communicate user inputs from one or more users to the server 200 and may include keyboards, mice, joysticks, touch screens, etc. A communication or network interface 225 is provided which allows the server 200 to communicate with other computer systems via an electronic communications network, including wired and/or wireless communication and including an Intranet or the Internet. In one embodiment, the server 200 receives instructions and user inputs from a remote computer through communication interface 225. Communication interface 225 can comprise a transmitter and receiver for communicating with remote devices. An optional display device 250 may be provided which can be any device capable of displaying visual information in response to a signal from the server 200. The components of the server 200, including the processing unit 205, the database 210, the data storage 215, the user input devices 220, the communication interface 225, and the display device 250, may be coupled via one or more data buses 260.

In the embodiment of FIG. 2, a graphics system 230 may be coupled with the data bus 260 and the components of the server 200. The graphics system 230 may include a physical graphics processing arrangement (GPU) 235 and graphics memory. The GPU 235 generates pixel data for output images from rendering commands. The physical GPU 235 can be configured as multiple virtual GPUs that may be used in parallel (concurrently) by a number of applications or processes executing in parallel. For example, mass scaling processes for rigid bodies or a variety of constraint solving processes may be run in parallel on the multiple virtual GPUs. Graphics memory may include a display memory 240 (e.g., a framebuffer) used for storing pixel data for each pixel of an output image. In another embodiment, the display memory 240 and/or additional memory 245 may be part of the database 210 and may be shared with the processing unit 205. Alternatively, the display memory 240 and/or additional memory 245 can be one or more separate memories provided for the exclusive use of the graphics system 230. In another embodiment, the graphics processing arrangement 230 may include one or more additional physical GPUs 255, similar to the GPU 235. Each additional GPU 255 may be adapted to operate in parallel with the GPU 235. Each additional GPU 255 generates pixel data for output images from rendering commands. Each additional physical GPU 255 can be configured as multiple virtual GPUs that may be used in parallel (concurrently) by a number of applications or processes executing in parallel, e.g., processes that solve constraints. Each additional GPU 255 can operate in conjunction with the GPU 235, for example, to simultaneously generate pixel data for different portions of an output image, or to simultaneously generate pixel data for different output images. Each additional GPU 255 can be located on the same circuit board as the GPU 235, sharing a connection with the GPU 235 to the data bus 260, or each additional GPU 255 can be located on another circuit board separately coupled with the data bus 260. Each additional GPU 255 can also be integrated into the same module or chip package as the GPU 235. Each additional GPU 255 can have additional memory, similar to the display memory 240 and additional memory 245, or can share the memories 240 and 245 with the GPU 235. It is to be understood that the circuits and/or functionality of GPU as described herein could also be implemented in other types of processors, such as general-purpose or other special-purpose coprocessors, or within a CPU.

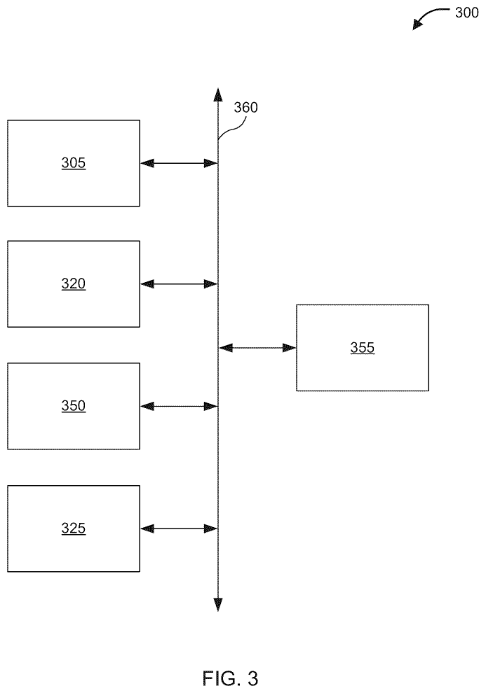

The computing system 100 may also include a user device 300 (as shown in FIG. 3). Herein, FIG. 3 is a block diagram of an example of the user device 300 capable of implementing embodiments according to the present disclosure. In the example of FIG. 3, the user device 300 may include a processor 305 (hereinafter, referred to as CPU 305) for running software applications (such as, the application 120 of FIG. 1) and optionally an operating system. A user input device 320 is provided which may include devices that communicate user inputs from one or more users. In the present embodiments, the user input device 320 may be in the form of a microphone (or a set/array of microphones). In some examples, the user input device 320 may further include keyboards, mice, joysticks, touch screens, etc., without any limitations. Further, a network adapter 325 is provided which allows the user device 300 to communicate with other computer systems (e.g., the server 200 of FIG. 2) via an electronic communications network, including wired and/or wireless communication and including the Internet. The user device 300 may also include a decoder 355 may be any device capable of decoding (decompressing) data that may be encoded (compressed). A user output device 350 may be provided which may be any device capable of communicating information, including information received from the decoder 355. Herein, the user output device 350 may be in the form of a speaker or a display device. In particular, as will be described below, the user output device 350 as the display device may provide an interface, such that the user output device 350 is configured to display information received from the server 200 of FIG. 2. The components of the user device 300 may be coupled via one or more data buses 360.

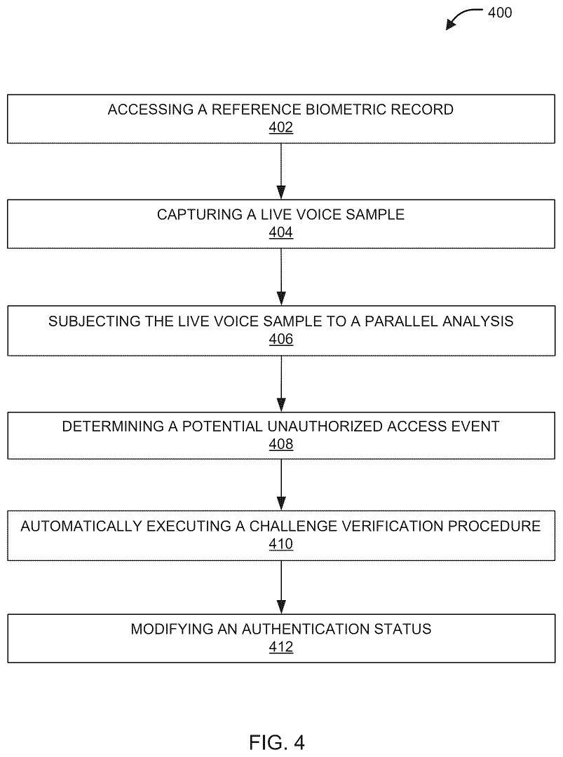

The above description for the general computing environment of FIGS. 1-3 provides general system context for the method and system described herein. The computing system 100, the server 200, and the user device 300 are examples of hardware upon which the described method and systems may be implemented. The description will now turn to the specific method and system embodiments, beginning with the updated FIG. 4.

For purposes of the present disclosure, the computing system 100 may be implemented for continuous authentication in communication sessions through a combination of biometric analysis and artificial intelligence technologies. The server 200 and the user device 300 act as integral components of the overall architecture of the computing system 100 for continuous authentication of participant(s) in a communication session. The server 200 provides the core processing capabilities and data storage necessary for the continuous authentication process. The user device 300 is configured to interact with the server 200 and is integral in initiating the authentication process. The user input device 320 represents the hardware and software that facilitates audio capture and initial processing. The server 200 receives the voice data from the user device 300 and performs a series of operations. The computing system 100 may employ a secure mechanism by which the voice data is transmitted from the user device 300 to the server 200. This may involve encryption or other security measures to ensure the data cannot be intercepted or tampered with during transmission. The server 200 includes one or more processors and a memory that stores instructions, which when executed by the processors, facilitate various operations of the continuous authentication process.

Specifically, in present implementations, the user device 300 may embody a wide variety of devices which may be implemented across various communication environments and devices requiring sustained security verification throughout a communication session. These implementations may include, for example, but not limited to: a) video conferencing platforms used for corporate board meetings, financial discussions, or sensitive business negotiations, where continuous verification of all participants'identities is crucial throughout the entire session; b) remote workplace collaboration tools where employees discuss confidential project details, requiring ongoing authentication to prevent unauthorized access or identity spoofing during the session; c) telemedicine platforms where healthcare providers conduct patient consultations, ensuring continuous verification of both the provider's and patient's identity throughout the medical consultation; d) remote educational platforms, particularly during high-stakes examinations or assessments, where continuous authentication helps maintain academic integrity by ensuring the authenticated student remains present throughout the entire session; e) military or defense communication systems where tactical discussions between field units require persistent verification of all participants'identities throughout the mission-critical communication; f) financial advisory services conducting remote client consultations involving sensitive financial planning or investment discussions, where continuous identity verification helps prevent fraudulent impersonation during the session; g) legal proceedings conducted remotely, such as depositions or mediations, where continuous authentication ensures the integrity of the proceedings by verifying participants'identities throughout the session; h) customer service environments handling sensitive account information, where continuous authentication helps prevent unauthorized access during account management or transaction processing sessions.

Referring to FIG. 4, illustrated is a flowchart of a method 400 for continuous authentication of participant(s) in a communication session, in accordance with one or more exemplary embodiments of the present disclosure. The method 400 provides continuous biometric authentication throughout an ongoing communication session by implementing a combination of authentication algorithms and verification procedures. The method 400 enables real-time monitoring and verification of participant identities through voice biometric analysis during audio or video communication sessions. The method 400 operates by processing voice data captured at predetermined intervals during the communication session and comparing the processed data against previously stored reference data. Through implementation of multiple parallel authentication techniques and dynamic threshold adjustment mechanisms, the method 400 maintains security of the communication session by detecting and responding to potential unauthorized access attempts, including both manual participant substitution and technological impersonation attempts. The method 400 incorporates machine learning and statistical modeling techniques to analyze voice characteristics and determine authenticity of participants on a continuous basis throughout the duration of the communication session.

At step 402, the method 400 involves accessing, by one or more processors (e.g., of server 200), a reference biometric record associated with the participant. This reference biometric record may be referred to as a “golden master” biometric record. The method 400 requires the reference biometric record to contain one or more original voice recordings of the authorized participant, specifically excluding any recordings of recordings to maintain authenticity of the voice data. In some embodiments, the reference biometric record comprises a first component and a second component. The first component includes text-dependent voice samples of the participant, for example, voice samples of the authorized participant speaking each numerical digit from zero through nine, which are primarily used for a challenge verification procedure (as discussed later). The second component includes a text-independent free speech audio sample, for example of approximately fifteen seconds duration, which is primarily used for the passive, continuous biometric comparison process. The reference biometric record further includes timestamp data indicating when the reference biometric record was captured, enabling tracking of the age of the reference data. In some embodiments, the method 400 involves prompting the participant to perform periodic updates of the reference biometric record at predetermined intervals, such as every one to two years, to account for natural changes in biometric characteristics or biometric aging. The reference biometric record requires explicit approval from each authorized participant for use in continuous authentication processes.

The method 400 further includes storing the reference biometric record in a secure database. In some embodiments, the reference biometric record is stored as a non-fungible token (NFT) in a blockchain network. The method 400 generates non-fungible tokens containing the reference biometric record of each authorized participant. Each non-fungible token comprises a unique digital asset that contains the voice samples and associated timestamp data from the reference biometric record. The method 400 incorporates digital encryption techniques during the generation of the non-fungible tokens to ensure the contained biometric data cannot be altered or tampered with once stored. After generation of the non-fungible tokens, the method 400 stores these tokens in a blockchain network. This approach provides significant security and integrity benefits for the stored reference data. The blockchain network provides a decentralized storage mechanism where multiple nodes maintain copies of the stored non-fungible tokens, preventing single points of failure or unauthorized modification of the stored reference biometric records. The method 400 maintains an access control list within the blockchain network that specifies which entities or systems have permission to access the stored non-fungible tokens containing the reference biometric records. This access control list is also stored on the blockchain network, ensuring that any modifications to access permissions are tracked and verified through the blockchain consensus mechanism. The method 400 requires authentication and authorization checks against this access control list before allowing retrieval or usage of the stored reference biometric records during continuous authentication processes. In embodiments utilizing the blockchain network, prior to the accessing of the reference biometric record for the parallel analysis, the one or more processors perform an integrity verification of the non-fungible token. The one or more processors query the blockchain network to verify that the non-fungible token remains present on the blockchain network and that a cryptographic hash value of the non-fungible token matches an expected hash value. The integrity verification further comprises confirming that the non-fungible token has not been revoked or superseded according to policy metadata stored on the blockchain network. Responsive to satisfying the integrity verification, the one or more processors decrypt and load the reference biometric record for utilization in the continuous authentication. Such blockchain-based storage mechanism enables secure distribution of the reference biometric records across multiple geographic locations while maintaining strict control over access and usage of the stored biometric data.

At step 404, the method 400 involves capturing, by one or more processors, a live voice sample from the participant during the communication session, at predetermined intervals. The method 400 may capture segments of 15-20 seconds duration from the communication session while the session remains active and ongoing. In some embodiments, this interval is periodic, while in other embodiments, the interval may be dynamically adjusted. For audio conference sessions, the method 400 captures the live biometric samples through direct audio stream recording. For video conference sessions, the method 400 implements a fork of the voice channel to capture the audio component for biometric analysis. The method 400 executes this capture process continuously throughout the duration of the communication session, with each capture interval providing a new set of live biometric samples for authentication. The capture process operates without interruption to the natural flow of communication between participants. The method 400 requires prior explicit approval from all participants regarding the continuous capture and authentication of voice samples during the communication session. During each capture interval, the method 400 records the complete audio stream containing voices of all active speakers in the communication session. The captured live biometric samples maintain the original audio characteristics including background acoustics and ambient conditions present during the communication session. The captured live biometric samples serve as input for subsequent speaker separation and authentication processes performed by the method 400.

In some implementations, the communication session comprises a plurality of participants. In such cases, the captured live voice sample comprises a multi-speaker audio stream. In such cases, the method 400 further comprises, prior to subjecting the live voice sample to the parallel analysis, performing speaker identification on the live voice sample to separate the live voice sample into one or more individual participant voice samples. The method 400 processes the captured multi-speaker audio stream to identify and isolate distinct voice segments belonging to different participants in the communication session. For instance, for a communication session containing three participants, the method 400 generates three separate audio files, with each file containing isolated speech segments from one distinct participant. The speaker identification process operates on the complete duration of each captured live biometric sample to ensure comprehensive separation of all participant voices. The method 400 implements speaker diarization technique for this process without requiring participants to speak in designated time slots or follow specific speaking patterns, enabling natural conversation flow while maintaining effective speaker separation. The separated individual participant samples provide distinct voice data streams that enable parallel processing for each participant in the communication session.

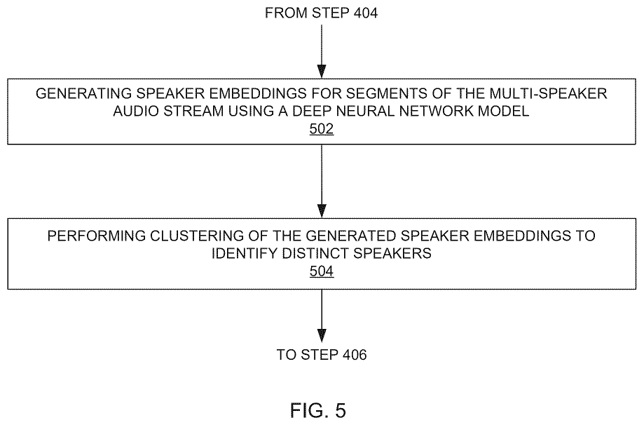

In present implementations, as detailed with reference to FIG. 5, the method 400 performs speaker identification through a multi-stage process. Herein, the method 400 implements separation of the multi-speaker audio stream into individual speaker segments. The method 400 analyzes the complete audio stream to identify boundaries between different speakers based on acoustic transitions and voice characteristic changes. The separation process generates discrete segments where each segment contains speech from a single participant, enabling isolated analysis of individual voices from the communication session.

In a first stage, at block 502, the method 400 processes each separated speaker segment to generate speaker embeddings. These speaker embeddings comprise mathematical representations of voice characteristics extracted from the audio data. The method 400 may utilize a deep neural network model to convert the raw audio data of each segment into compact numerical vectors that capture distinct voice features of the speaker.

For present purposes, the deep neural network model utilized for generating the speaker embeddings may comprise a discriminative speaker-embedding network architecture, such as an x-vector architecture or an ECAPA-TDNN architecture. The deep neural network model utilizes a stack of time-delay neural network (TDNN) layers or TDNN-ResNet layers to aggregate temporal context around frame-level features, such as Mel-frequency cepstral coefficients (MFCCs) or log-mel filterbank energies converted from the live voice sample. The deep neural network model may further apply a statistical pooling layer to aggregate frame-level representations over a duration of the segment to produce a fixed-length vector independent of the duration of the segment. Regarding the performing of clustering, the method 400 utilizes an unsupervised clustering algorithm, such as agglomerative hierarchical clustering (AHC), employing a cosine-distance metric to iteratively merge closest clusters of the speaker embeddings until a stopping criterion is met. In embodiments involving live streams, the clustering operates in an online mode wherein centroids of the clusters are updated incrementally as new segments of the multi-speaker audio stream arrive.

In a second stage, at block 504, the method 400 performs clustering of the generated speaker embeddings to identify distinct speakers within the communication session. The clustering process groups speaker embeddings with similar voice characteristics, where each resulting cluster corresponds to a unique participant in the communication session. The method 400 applies machine learning algorithms to determine optimal clustering of the speaker embeddings, enabling accurate identification of distinct speakers even in cases of overlapping speech or varying acoustic conditions. This speaker identification process enables the method 400 to maintain separate voice streams for each participant throughout the communication session, facilitating continuous individual authentication of all participants.

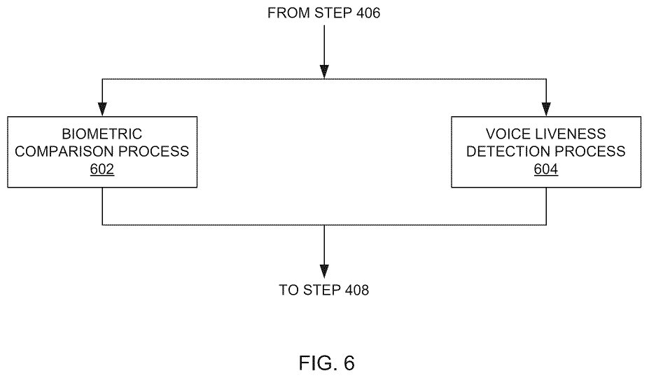

At step 406, the method 400 involves subjecting, by one or more processors, the live voice sample to a parallel analysis. This parallel analysis is illustrated in FIG. 6. The parallel analysis comprises at least two distinct processes performed on the same live voice sample: a biometric comparison process 602 and a voice liveness detection process 604.

The first path of the parallel analysis is the biometric comparison process 602, wherein the live voice sample is compared against the reference biometric record to generate an authentication score. These comparisons are performed to determine authenticity of participants in the communication session. These comparisons occur continuously throughout the duration of the communication session, enabling constant verification of participant identities. The comparison process analyzes multiple aspects of voice characteristics present in both the captured live biometric sample and the reference biometric record to establish identity matches. The method 400 utilizes advanced signal processing and pattern recognition techniques to perform these comparisons, accounting for natural variations in human voice while maintaining ability to detect unauthorized participants. The comparison process generates quantitative measures of similarity between the captured live biometric sample and the reference biometric record, enabling objective evaluation of participant authenticity.

In present embodiments, the comparison process begins with extraction of acoustic features from the captured live biometric sample. This step may involve using mel-frequency cepstral coefficients. The method 400 implements a sequential feature extraction process comprising: pre-emphasis of the audio signal to amplify high frequencies, splitting of the signal into short overlapping frames of 20-40 milliseconds duration, application of a window function to minimize spectral distortions, computation of Fast Fourier Transform to convert time-domain signals to frequency domain, calculation of the modulus of the Fourier transform output, application of mel filters to mimic human auditory response, implementation of Discrete Cosine Transform for de-correlation, and performance of cepstral mean variance normalization. The method 400 then generates statistical models using Gaussian mixture models (GMM) to represent the distribution of the extracted acoustic features. The statistical modeling process involves creation of a universal background model that represents the general distribution of acoustic features across all speakers. The method 400 applies maximum a posteriori adaptation techniques to adapt the universal background model for specific speaker characteristics. The method 400 further computes similarity scores using universal background models as reference points for speaker verification. These background modeling techniques enable the method 400 to distinguish between variations in voice characteristics that indicate different speakers versus natural variations in a single speaker's voice. The method 400 may also apply speaker adaptation techniques during the comparison process to account for session variability, including adjustments for different acoustic environments and channel characteristics between the reference biometric record and the captured live biometric sample.

In present embodiments, the biometric comparison process may be performed by one or more parallel authentication algorithms. These parallel authentication algorithms may include at least two of: i-vector based authentication; d-vector based authentication; x-vector based authentication; and neural network based authentication. Each algorithm provides a different technical approach to voice analysis. The i-vector based authentication implements a subspace projection technique that decomposes speaker variability into compact vectors. The i-vector based authentication captures both speaker-specific characteristics and session variability through statistical modeling. The method 400 implements i-vector based authentication using Gaussian mixture models and universal background models to represent statistical distributions of acoustic features. The d-vector based authentication employs deep neural networks trained to classify speakers based on voice characteristics. The method 400 uses d-vector based authentication to generate speaker embeddings from a deep neural network that maps speech segments to vector representations uniquely identifying each speaker. The d-vector based authentication may demonstrate optimal performance for speaker identification scenarios, particularly in identifying speakers from a library of voice samples. The x-vector based authentication implements time-delay neural networks designed to handle real-world challenges including noise and environmental variations. The x-vector based authentication processes both short-term and long-term temporal contexts of speech data to generate speaker representations. The method 400 applies x-vector based authentication through implementation of specialized neural network architectures that analyze multiple time scales of voice data simultaneously. The neural network based authentication utilizes additional deep learning models specifically trained on organization-specific voice data. The method 400 implements neural network based authentication using models that have undergone extensive training on diverse voice samples to ensure reliable performance across different acoustic conditions and speaker characteristics. The parallel execution of multiple authentication algorithms enables the method 400 to leverage complementary strengths of different approaches while maintaining high accuracy in varying operational conditions.

The second path of the parallel analysis is the voice liveness detection process 604, wherein a voice liveness verification test is performed on the live voice sample. This process, also referred to as Voice Liveness Detection (VLD), functions as a countermeasure against presentation attacks. Such attacks include attempts to spoof the authentication system using non-live voice samples, such as pre-recorded voice samples of the authorized participant (a replay attack) or artificially generated speech synthesized to mimic the participant's voice (a synthetic voice or deepfake attack). Unlike the biometric comparison process, which primarily determines who is speaking, the voice liveness detection process 604 determines if the speech is being produced by a live, physically present human speaker.

The voice liveness verification test operates by analyzing intrinsic acoustic properties and artifacts within the live voice sample that are characteristic of live human speech but are difficult for artificial systems to replicate accurately. The test may analyze high-frequency harmonics and formants that are naturally produced by the human vocal tract but are often absent or distorted in synthesized speech. Furthermore, the test may analyze subtle acoustic patterns such as glottal-flow characteristics, micro-variations in pitch and timing, or the specific type of background noise and channel artifacts (e.g., microphone pops, breathing sounds) to differentiate between a live utterance and a recorded playback. The result of this voice liveness detection process 604 is a determination, such as a binary “live” or “non-live” classification or a numerical liveness score, which provides a separate and parallel signal for the subsequent event determination step.

Herein, the voice liveness verification test analyzes micro-temporal variability within the live voice sample, including rapid, non-repeating variations in pitch contour, short-term jitter, and shimmer patterns characteristic of live speech. The analysis includes detection of phase discontinuities and unnatural alignment across harmonics introduced by playback devices or generative models. The voice liveness detection process 604 further inspects spectral fine structure for turbulence noise at fricatives and plosives, and monitors energy dynamics for natural attack and decay patterns. The test identifies artifacts specific to neural synthesis models, including vocoder quantization noise and temporal grid patterns, to distinguish the live voice sample from a synthetic generation. The analysis may further include detection of device-induced acoustic footprints, such as speaker resonance signatures and room impulse response coloration, to identify replay attacks passing through intermediate devices.

Furthermore, in some embodiments, the biometric comparison process itself further comprises an anti-replay logic. This logic includes the sub-steps of calculating a similarity value between the live voice sample and the reference biometric record. This similarity value may be an i-vector score or similar metric. The method 400 then involves comparing the similarity value to a predefined anti-replay threshold. This threshold is set at a value indicating an extremely high, or “too perfect,” match, which is characteristic of a replay attack using the original recording. Responsive to determining the similarity value exceeds this predefined anti-replay threshold, the method 400 determines the potential unauthorized access event has occurred.

After comparing the captured live biometric sample against the corresponding reference biometric record, the method 400 generates an authentication score that represents the degree of similarity between the two sets of biometric data. The authentication score comprises a numerical value calculated from the similarity scores computed through the background modelling techniques. For each authentication algorithm operating in parallel, the method 400 generates a separate authentication score. For instance, when using i-vector authentication, the method 400 generates scores in a range that indicates the likelihood of the captured live biometric sample matching the voice characteristics stored in the reference biometric record. For d-vector and x-vector authentication algorithms, the method 400 computes scores based on the distance between extracted feature vectors of the captured sample and the reference biometric record.

At step 408, for each separated individual participant sample, the method 400 involves determining, by one or more processors, that a potential unauthorized access event has occurred. This determination is based on the results from the parallel analysis at step 406. Specifically, the event is determined based on the authentication score from the biometric comparison process failing to meet an authentication threshold and/or the result of the voice liveness detection process indicating a non-live source. Herein, the authentication threshold represents a minimum score value required to verify the identity of a participant. When the authentication score exceeds the adjusted threshold value, the method 400 determines a positive authentication status. When the authentication score falls below the threshold, the method 400 determines a negative authentication status indicating potential unauthorized access. Similarly, a failure of the liveness test also indicates a potential unauthorized access event.

In specific embodiments, the determination of the potential unauthorized access event utilizes a hierarchical, priority-based evaluation logic wherein the voice liveness detection process 604 functions as a mandatory gate prior to evaluation of the authentication score. The system generates a replay-risk value on a normalized scale, for example from 0.0 to 1.0, based on the voice liveness verification test. If the replay-risk value exceeds a predefined replay-detection threshold, configured for example within a range of 0.60 to 0.85, the system determines that the potential unauthorized access event has occurred and rejects the live voice sample regardless of the authentication score. Only upon the live voice sample passing the voice liveness detection process 604 does the system evaluate the authentication score against the authentication threshold. The authentication threshold is configured, for example, within a normalized range of 0.30 to 0.60. A failure of the authentication score to meet the authentication threshold, subsequent to passing the voice liveness detection process 604, results in the determination of the potential unauthorized access event.

In some embodiments, the method 400 utilizes different threshold values for different authentication algorithms, with each threshold optimized for the specific scoring characteristics of its corresponding algorithm. This implementation of maintaining separate threshold comparisons for each parallel authentication algorithm enables the method 400 to perform verification through multiple independent assessments, ensuring comprehensive authentication.

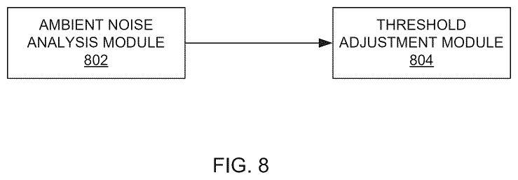

In some embodiments, the method 400 implements dynamic adjustment of the authentication threshold. This mechanism is illustrated schematically in FIG. 8. The method 400 involves determining ambient noise conditions in the communication session by analyzing the live voice sample, for example, through analysis of signal-to-noise ratios and frequency distribution patterns in the captured audio stream. The background acoustic conditions determined by the method 400 include characteristics such as reverberation, echo effects, and acoustic channel properties present during the communication session. The method 400 analyzes these conditions by processing non-speech segments of the captured audio stream and extracting acoustic environment parameters. FIG. 8 illustrates an ambient noise analysis module 802 providing input to a threshold adjustment module 804. The method 400, then, involves dynamically adjusting the authentication threshold based on the determined conditions. For environments with high ambient noise levels, the method 400 adjusts the threshold to prevent false rejections caused by noise interference with voice characteristics. In conditions with strong background acoustics effects, the method 400 modifies the threshold to account for distortions in the captured voice samples. The method 400 maintains separate predefined target rates for false positive authentications and false negative authentications to prevent incorrect acceptance and rejection of authorized participants, respectively. When background conditions change during a communication session, the method 400 continuously updates the threshold values.

In present implementations, the method 400 applies different threshold adjustment factors for different parallel authentication algorithms, with each adjustment optimized for the specific sensitivity of its corresponding algorithm to environmental conditions. The dynamically adjusting of the authentication threshold comprises computing acoustic quality metrics including estimated signal-to-noise ratio (SNR) and noise-floor stability of the communication session. Upon detection of a low SNR or non-stationary noise floor indicative of a noisy environment, the system relaxes the authentication threshold to a lower value within a predefined operating range to mitigate false rejections of the authorized participant. Responsive to relaxing the authentication threshold, the system applies compensating controls to maintain security integrity, including increased weighting of the result of the voice liveness detection process 604 or cross-checking consistency across multiple segments of the live voice sample.

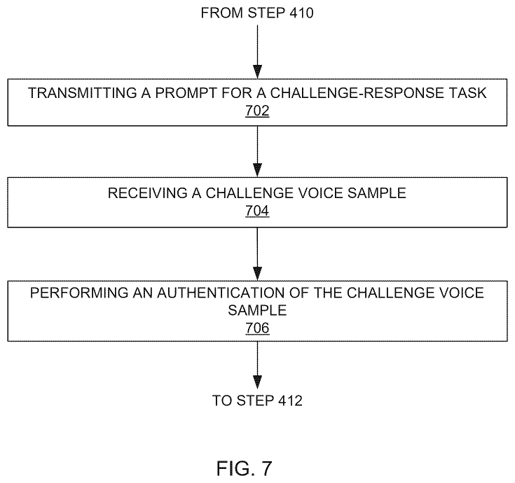

At step 410, responsive to determining the potential unauthorized access event at step 408, the method 400 involves automatically executing a challenge verification procedure. This execution is an automatic, system-initiated response triggered by the determination of the potential unauthorized access event, and does not require manual intervention from a session administrator. This procedure is detailed in FIG. 7. The challenge verification procedure provides a secondary, active verification mechanism to confirm or deny the potential unauthorized access event. The challenge verification procedure comprises, at block 702, transmitting, by one or more processors, a prompt for a challenge-response task to the participant associated with the potential unauthorized access event.

In some embodiments, the challenge-response task comprises prompting the participant to speak a generated random sequence of digits. The one or more processors first generate this random sequence of digits, ensuring that the challenge is unique for each execution of the procedure and cannot be pre-recorded by an attacker. The prompt itself contains these generated digits and instructs the participant to utter them. In present implementations, the generated random sequence of digits comprises a sequence of approximately ten digits configured to be spoken individually and without repetition by the participant. The system processes each digit of the sequence independently to extract an embedding and evaluates the embedding against the reference biometric record. The system aggregates individual similarity scores derived from each digit using a pooling method, such as median pooling or percentile-based pooling, to derive the challenge result. The authentication of the challenge voice sample utilizes an authentication threshold consistent with the authentication threshold utilized for the biometric comparison process 602 of the live voice sample, applying the same underlying speaker embedding space and similarity scoring function. In an alternative embodiment, the challenge-response task comprises prompting the participant to speak a predetermined passphrase. In this embodiment, the reference biometric record further includes one or more enrollment recordings of the participant speaking the predetermined passphrase. Responsive to the determining of the potential unauthorized access event, the one or more processors transmit the prompt instructing the participant to speak the predetermined passphrase. The system compares the received challenge voice sample against the enrollment recordings of the predetermined passphrase using the same speaker-embedding space and similarity scoring function utilized for the generated random sequence of digits.

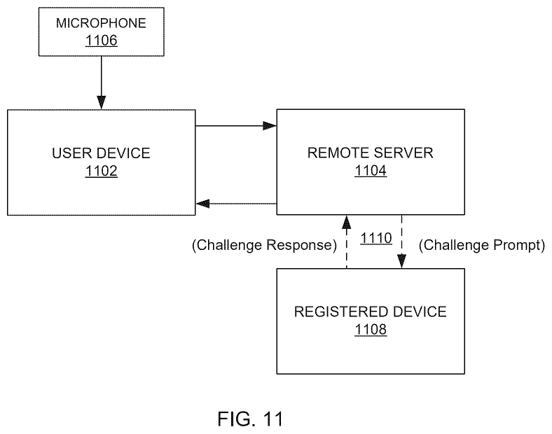

In present embodiments, the step of transmitting the prompt for the challenge-response task may comprise transmitting a separate authentication request to a registered device associated with the participant, as illustrated by registered device 1108 in FIG. 11. This registered device, such as a smartphone or personal tablet, is separate from the primary device (e.g., user device 1102) being used for the main communication session. The transmission of this separate authentication request occurs via a secure out-of-band channel 1110. This secure out-of-band channel is a communication path, such as a cellular network (e.g., Short Message Service) or a secured push notification to a dedicated application on the registered device, which is logically and physically separate from the network channel of the ongoing communication session. This separation ensures that an attacker who has compromised the primary communication session cannot intercept or interfere with the challenge prompt.

Following the transmission of the prompt, the method 400 further comprises, at block 704, receiving, by one or more processors, a challenge voice sample from the participant in response to the prompt. The participant speaks the random sequence of digits into the registered device, and the registered device captures this utterance as the challenge voice sample. This challenge voice sample is then transmitted back to the one or more processors, for example, at the remote server 1104.

Upon receiving the challenge voice sample, the challenge verification procedure further comprises, at block 706, performing, by one or more processors, an authentication of the challenge voice sample to generate a challenge result. This authentication is a text-dependent verification. The one or more processors compare the received challenge voice sample against the reference biometric record, specifically, against the first component of the record that includes the text-dependent voice samples of the participant speaking digits. The authentication may apply the same biometric comparison algorithms, such as i-vector or x-vector analysis, used in the main authentication loop, but applied in a text-dependent context. The outcome of this authentication is the challenge result, which may be a binary pass/fail status or a score, indicating whether the voice sample matches the biometric data of the participant and the correct sequence of digits.

For present implementations, this challenge verification procedure is executed not only in response to standard authentication failures (i.e., a low authentication score) but also in response to failures of the voice liveness detection process. The method 400 may be configured to perform detection of potential deepfake audio, as described in step 406. When either the biometric comparison process fails, or the voice liveness detection process indicates a non-live source, the method 400 executes the challenge verification procedure as described. The method 400 applies both standard authentication and liveness analysis to the received challenge voice sample, ensuring verification of participant identity and voice authenticity. This layered approach provides a mechanism to counter both traditional impersonation attempts and advanced deepfake attacks.

At step 412, the method 400 includes modifying, by one or more processors, an authentication status of the participant based on the challenge result (from step 410). If the challenge result is positive (i.e., the participant is authenticated), the authentication status is maintained or restored. If the challenge result is negative (i.e., an authentication failure), the method 400 modifies the authentication status, which may include terminating access to the communication session for the participant who failed the challenge verification. When the authentication status remains positive (either continuously or after a successful challenge), the method 400 maintains standard operation of the communication session without interruption. When the authentication status indicates potential unauthorized access, the method 400 generates notification signals to designated session administrators or security monitors. The notification includes specific identification of the participant whose authentication status indicated potential unauthorized access, enabling targeted response measures.

More specifically, in present implementations, the modifying of the authentication status may comprise directly controlling media channels associated with the participant within the communication session. For example, responsive to the authentication status indicating that the participant has failed the challenge verification procedure, the one or more processors may automatically mute an audio channel of the participant, blur a video stream of the participant, or disconnect the participant from the communication session. Responsive to the authentication status indicating a challenged state while the challenge verification procedure is pending, the system may restrict the participant to receive-only access. Additionally, the system may mark portions of the communication session corresponding to the potential unauthorized access event in a session log. The marking comprises storing a timestamp range, an identifier of the participant, and the authentication score in the session log associated with a stored recording of the communication session. The system may further generate a real-time indicator, such as a colored border or icon adjacent to a media tile of the participant, on a user interface presented to other participants to reflect the current authentication status.

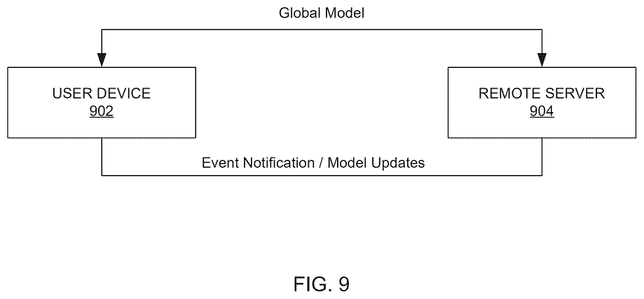

For purposes of the present disclosure, the method 400 may be implemented in a distributed or hybrid architecture, as illustrated in the schematic of FIG. 9. In this architecture, the step of subjecting the live voice sample to the parallel analysis (step 406) is performed on a user device 902 associated with the participant. The user device 902 comprises a first processor. Performing the parallel analysis locally on the user device 902 provides for low-latency processing of the live voice sample. Responsive to determining the potential unauthorized access event (step 408) by the first processor, the user device 902 transmits an event notification to a remote server 904. The remote server 904 comprises a second processor. The challenge verification procedure (step 410) is then executed by the second processor on the remote server 904. This distribution of tasks enhances security by executing the determinative challenge verification procedure on a separate, secure computing system.

In further embodiments, the method 400 may comprise steps for low-bandwidth adaptation. The method 400 further comprises determining a network bandwidth quality for the communication session. This determination may be made by analyzing network latency, packet loss, or available throughput. Based on the determined network bandwidth quality, the method 400 further comprises dynamically adjusting a complexity of feature vectors extracted during the biometric comparison process. For example, in a determined low-bandwidth condition, the method 400 may reduce the dimensionality of the feature vectors, such as i-vectors or x-vectors. This adjustment ensures that the biometric comparison process can continue in a timely manner without significant degradation of authentication accuracy, even in constrained network environments.

In some embodiments, the method 400 may further comprise performing adaptive sampling of the live voice sample. This comprises analyzing a context of the communication session. The context may be determined by monitoring session metadata or analyzing the content of the communication. The context comprises, for example, a new participant joining the communication session, a high-value transaction being discussed, or a detected change in conversation topic based on keyword analysis. Based on the analyzed context, the method 400 further comprises dynamically adjusting a periodic interval for capturing the live voice sample (step 404). For instance, upon detecting a high-risk context, such as a new participant joining, the method 400 may decrease the interval to increase the frequency of capture, thereby providing more frequent authentication during periods of heightened potential risk.

In another embodiment, the method 400 may be implemented using a federated learning architecture, as also represented in FIG. 9. In this embodiment, the reference biometric record is part of a global authentication model, which may be stored on a remote server (e.g., server 904). The method 400 further comprises updating a local model on a user device (e.g., user device 902) using the live voice sample captured during the session. After the local model is updated, the method 400 further comprises aggregating updates from the local model into the global authentication model. These updates may comprise, for example, model gradients or updated model weights, rather than the raw biometric data itself. This aggregation is performed without transmitting the live voice sample from the user device. This federated approach provides a significant privacy advantage, as the raw live voice sample is never transmitted from the user device, and the global authentication model is improved by processing updates from many distributed local models.

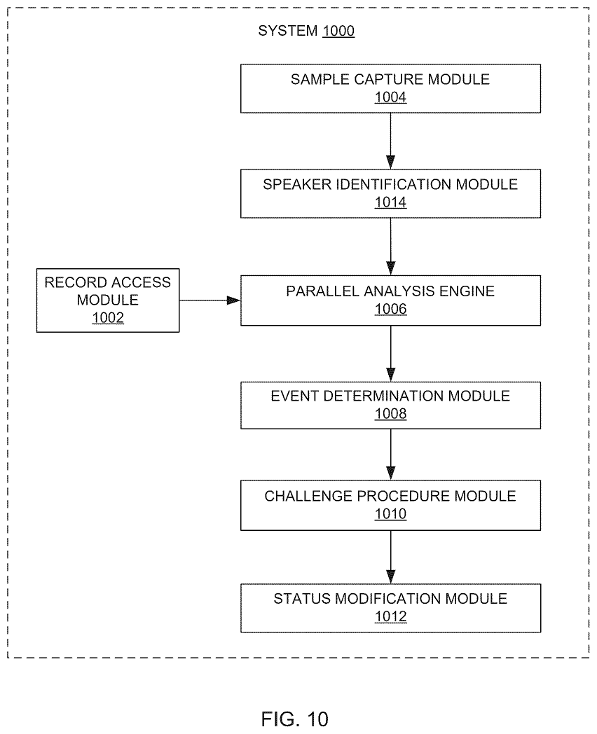

The present disclosure provides a system for continuous authentication. The system architecture is illustrated in various embodiments, including the logical module diagram of FIG. 10 and the distributed architecture of FIG. 11. Referring to FIG. 10, a system 1000 for continuous authentication is shown. The system 1000 comprises one or more processors (e.g., of server 200 or user device 300) and a memory communicatively coupled to the one or more processors. The memory stores program instructions which, when executed by the one or more processors, configure the system as a set of logical modules.

As shown in FIG. 10, these modules include a record access module 1002 configured to access the reference biometric record associated with the participant; a sample capture module 1004 configured to receive a live voice sample from the participant; and a parallel analysis engine 1006. The parallel analysis engine 1006 is configured to subject the live voice sample to the parallel analysis, comprising a biometric comparison process (as described in relation to FIG. 6) and a voice liveness detection process. The system 1000 further includes an event determination module 1008 configured to determine that a potential unauthorized access event has occurred based on the output of the parallel analysis engine 1006. Responsive to such a determination, a challenge procedure module 1010 is configured to automatically execute the challenge verification procedure (as described in relation to FIG. 7). Finally, a status modification module 1012 is configured to modify an authentication status of the participant based on the challenge result.

In embodiments for multi-participant sessions, the system 1000 further comprises a speaker identification module 1014. The speaker identification module 1014 is configured to perform the speaker identification (as described in relation to FIG. 5) on a multi-speaker audio stream to separate the live voice sample into one or more individual participant voice samples before they are processed by the parallel analysis engine 1006. The steps of capturing the live voice sample, performing speaker identification, and subjecting the live voice sample to the parallel analysis are performed in a continuous loop for a duration of the communication session. The system treats each newly captured time window of the multi-speaker audio stream as a separate instance of the live voice sample and repeats the parallel analysis and the determining of the potential unauthorized access event for that time window. For the communication session comprising the plurality of participants, the one or more processors may operate concurrently on separate processing threads associated with each of the identified distinct speakers. The system maintains, for each of the participants, a rolling buffer of recent voice segments and a corresponding stream of authentication scores and results of the voice liveness detection process. This concurrent processing architecture enables the system to update the authentication status for all of the participants substantially in real time, independent of a number of the participants active in the communication session.

Referring now to FIG. 11, a distributed system architecture 1100 is illustrated. This architecture illustrates the distribution of system's components between a user device 1102 (e.g., user device 300) and a remote server 1104 (e.g., server 200).

In one embodiment, the system 1100 operates as a hybrid system, as also illustrated in FIG. 9. The user device 1102 comprises a first processor, and the remote server 1104 comprises a second processor. As illustrated in FIG. 11, the instructions that cause the system to subject the live voice sample to the parallel analysis may be executed by the first processor on the user device 1102. This allows for low-latency, on-device processing. Responsive to determining the potential unauthorized access event, the user device 1102 signals the remote server 1104. The instructions that cause the system to execute the challenge verification procedure are then executed by the second processor on the remote server 1104. This hybrid architecture enhances security by offloading the critical challenge-response mechanism to a secure, remote system.

In another embodiment, the system 1100 includes a microphone 1106 (e.g., part of user device 1102) configured to capture the live voice sample during the communication session. The system 1100 also comprises a separate registered device 1108 associated with the participant, which is separate from the device (user device 1102) utilized for the communication session. FIG. 11 shows the instructions that cause the processor (e.g., on server 1104) to transmit the prompt for the challenge-response task. These instructions transmit the prompt to the registered device 1108 via a secure out-of-band channel 1110, which is distinct from the primary communication channel used by device 1102.

In further aspects, the present disclosure provides a non-transitory computer-readable storage medium, such as storage device 116 or memory 215. The non-transitory computer-readable storage medium stores program instructions which, when executed by one or more processors, such as processing unit 205, cause the one or more processors to perform the method for continuous authentication as described in the steps of method 400. This includes causing the one or more processors to perform the steps of accessing the reference biometric record, capturing the live voice sample, subjecting the live voice sample to the parallel analysis, determining the potential unauthorized access event, automatically executing the challenge verification procedure, and modifying the authentication status, as well as the steps described in the various additional embodiments.

The present disclosure provides significant advancement in communication security through implementation of continuous authentication throughout active communication sessions. The method 400 for continuous authentication in communication sessions, as discussed herein, enables real-time detection of unauthorized access attempts through analysis of live biometric samples captured at predetermined intervals. The integration of multiple parallel authentication algorithms with speaker diarization capabilities enables the method to maintain separate authentication streams for each participant while allowing natural conversation flow. The implementation of non-fungible token storage in blockchain networks for reference biometric records provides secure, distributed storage with strict access control, preventing unauthorized modification or access to reference biometric data.

The method 400 for continuous authentication provides advantages over conventional authentication systems that verify participant identity only at session initiation. Through continuous capture and analysis of live biometric samples, the method 400 detects both willing participant substitution and technological impersonation attempts that occur after initial authentication. The implementation of parallel deepfake detection tests and voice liveness detection provides protection against advanced technological threats that bypass traditional authentication measures. The method 400 maintains security without disrupting communication flow through non-intrusive biometric sampling and processing. The dynamic adjustment of authentication thresholds based on ambient conditions enables consistent authentication accuracy across varying acoustic environments. The integration of challenge verification procedures provides additional security verification through separate communication channels when potential unauthorized access is detected, enabling prompt removal of unauthorized participants from active sessions.

While the present disclosure has been described in detail with reference to certain embodiments, it should be appreciated that the present disclosure is not limited to those embodiments. In view of the present disclosure, many modifications and variations may be present themselves, to those skilled in the art without departing from the scope of the various embodiments of the present disclosure, as described herein. The scope of the present disclosure is, therefore, indicated by the claims rather than by the foregoing description. All changes, modifications, and variations coming within the meaning and range of equivalency of the claims are to be considered within their scope.

What is claimed is:

1. A computer-implemented method for continuous authentication of a participant in a communication session, comprising:
accessing, by one or more processors, a reference biometric record associated with the participant, wherein the reference biometric record comprises one or more original voice recordings of the authorized participant;
capturing, by one or more processors, a live voice sample from the participant during the communication session;
subjecting, by one or more processors, the live voice sample to a parallel analysis, the parallel analysis comprising:
a biometric comparison process, wherein the live voice sample is compared against the reference biometric record to generate an authentication score; and
a voice liveness detection process, wherein a voice liveness verification test is performed on the live voice sample;
determining, by one or more processors, that a potential unauthorized access event has occurred based on the authentication score in comparison to an authentication threshold and a result of the voice liveness detection process;
responsive to determining the potential unauthorized access event, automatically executing a challenge verification procedure, the challenge verification procedure comprising:
transmitting, by one or more processors, a prompt for a challenge-response task to the participant;
receiving, by one or more processors, a challenge voice sample from the participant in response to the prompt; and
performing, by one or more processors, an authentication of the challenge voice sample to generate a challenge result; and
modifying, by one or more processors, an authentication status of the participant based on the challenge result.

2. The method as claimed in claim 1, wherein the communication session comprises a plurality of participants, and the method further comprises prior to subjecting the live voice sample to the parallel analysis, performing speaker identification on the live voice sample to separate the live voice sample into one or more individual participant voice samples, wherein the live voice sample comprises a multi-speaker audio stream.

3. The method as claimed in claim 2, wherein performing speaker identification comprises:
generating speaker embeddings for segments of the multi-speaker audio stream using a deep neural network model; and
performing clustering of the generated speaker embeddings to identify distinct speakers corresponding to the plurality of participants.

4. The method as claimed in claim 1, wherein transmitting the prompt for the challenge-response task comprises transmitting a separate authentication request to a registered device associated with the participant via a secure out-of-band channel.

5. The method as claimed in claim 1, wherein the challenge-response task comprises prompting the participant to speak a generated random sequence of digits.

6. The method as claimed in claim 1, wherein the biometric comparison process is performed by one or more parallel authentication algorithms selected from the group consisting of: i-vector based authentication, d-vector based authentication, x-vector based authentication, and neural network based authentication.

7. The method as claimed in claim 1, wherein the biometric comparison process further comprises:
calculating a similarity value between the live voice sample and the reference biometric record;
comparing the similarity value to a predefined anti-replay threshold; and
responsive to determining the similarity value exceeds the anti-replay threshold, determining the potential unauthorized access event has occurred.

8. The method as claimed in claim 1, further comprising:
determining ambient noise conditions in the communication session by analyzing the live voice sample; and
dynamically adjusting the authentication threshold based on the determined ambient noise conditions.

9. The method as claimed in claim 1, wherein the reference biometric record comprises a first component including text-dependent voice samples of the participant and a second component including a text-independent free speech audio sample.

10. The method as claimed in claim 1, further comprising prompting the participant to perform periodic updates of the reference biometric record at predetermined intervals to account for natural changes in biometric characteristics.

11. The method as claimed in claim 1, wherein the reference biometric record is stored as a non-fungible token in a blockchain network.

12. The method as claimed in claim 1, wherein subjecting the live voice sample to the parallel analysis is performed on a user device associated with the participant; and responsive to determining the potential unauthorized access event, the challenge verification procedure is executed on a remote server.

13. The method as claimed in claim 1, further comprising:
determining a network bandwidth quality for the communication session; and
dynamically adjusting a complexity of feature vectors extracted during the biometric comparison process based on the determined network bandwidth quality.

14. The method as claimed in claim 1, further comprising:
analyzing a context of the communication session; and
dynamically adjusting a periodic interval for capturing the live voice sample based on the context, wherein the context comprises a new participant joining the communication session or a change in conversation topic.

15. The method as claimed in claim 1, wherein the reference biometric record is part of a global authentication model, and further comprising:
updating a local model on a user device using the live voice sample; and
aggregating updates from the local model into the global authentication model without transmitting the live voice sample from the user device.

16. A system for continuous authentication of a participant in a communication session, the system comprising:
one or more processors; and
a memory communicatively coupled to the one or more processors, the memory storing program instructions which, when executed by the one or more processors, cause the one or more processors to:
access a reference biometric record associated with the participant, wherein the reference biometric record comprises one or more original voice recordings of the authorized participant;
receive a live voice sample from the participant captured during the communication session;
subject the live voice sample to a parallel analysis, the parallel analysis comprising:
a biometric comparison process, wherein the live voice sample is compared against the reference biometric record to generate an authentication score; and
a voice liveness detection process, wherein a voice liveness verification test is performed on the live voice sample;
determine that a potential unauthorized access event has occurred based on the authentication score in comparison to an authentication threshold and a result of the voice liveness detection process;
responsive to determining the potential unauthorized access event, automatically execute a challenge verification procedure, the challenge verification procedure comprising:
transmitting a prompt for a challenge-response task to the participant;
receiving a challenge voice sample from the participant in response to the prompt; and
performing an authentication of the challenge voice sample to generate a challenge result; and
modify an authentication status of the participant based on the challenge result.

17. The system as claimed in claim 16, wherein the communication session comprises a plurality of participants, and wherein the instructions, when executed by the one or more processors, further cause the one or more processors to prior to subjecting the live voice sample to the parallel analysis, perform speaker identification on the live voice sample to separate the live voice sample into one or more individual participant voice samples, wherein the live voice sample comprises a multi-speaker audio stream.

18. The system as claimed in claim 16, further comprising:
a user device associated with the participant; and
a remote server communicatively coupled to the user device,
wherein the one or more processors comprise a first processor of the user device and a second processor of the remote server,
wherein the instructions that cause the one or more processors to subject the live voice sample to the parallel analysis are executed by the first processor, and
wherein the instructions that cause the one or more processors to execute the challenge verification procedure are executed by the second processor.

19. The system as claimed in claim 16, further comprising:
a microphone configured to capture the live voice sample; and
a registered device associated with the participant, wherein the registered device is separate from a device utilized for the communication session,
wherein the instructions that cause the one or more processors to transmit the prompt for the challenge-response task comprise instructions to transmit the prompt to the registered device via a secure out-of-band channel.

20. A non-transitory computer-readable storage medium storing program instructions which, when executed by one or more processors, cause the one or more processors to perform the method according to claim 1.
